(19) United States
(12) Patent Application Publication
(10) Pub. No.: US 2014/0202662 A1
(43) Pub. Date: Jul. 24, 2014

(54) SPLITTERLESS INTERNAL HEAT EXCHANGER AND METHOD OF MANUFACTURING THE SAME

(71) Applicant: VISTEON GLOBAL TECHNOLOGIES, INC., Van Buren Twp, MI (US)

(72) Inventor: John Joseph Meyer, Northville, MI (US)

(73) Assignee: VISTEON GLOBAL TECHNOLOGIES, INC., Van Buren Twp., MI (US)

(21) Appl. No.: 13/747,815

(22) Filed: Jan. 23, 2013

(51) Int. Cl. F28F 1/00; B23P 15/26

(52) U.S. Cl. CPC F28F 1/00; B23P 15/26
USPC 165/104.14; 29/890.043

(57) ABSTRACT

A heat exchanger includes a first tube and a second tube. The first tube is configured to receive a liquid refrigerant from a condenser of the air conditioning system. The second tube is configured to receive a vapor refrigerant from an evaporator of the air conditioning system. The first tube is coupled to the second tube by at least one thermally conductive joint, wherein a length and a cross-sectional area of the at least one thermally conductive joint as well as an area of contact of the at least one thermally conductive joint with the tubes are based upon a desired heat conductivity between the liquid refrigerant and the vapor refrigerant.

### FIELD OF THE INVENTION

The present invention relates to a heat exchanger. More particularly, the invention is directed to a splitterless internal heat exchanger and a method of manufacturing the same.

### BACKGROUND OF THE INVENTION

A typical air conditioning system of a vehicle includes a compressor, a condenser, an expansion device, and an evaporator, all fluidly connected by refrigerant conduits. The refrigerant conduits are capable of conveying a flow of high and low-pressure refrigerant. Common refrigerants used in the air conditioning systems are environmentally friendly refrigerants such as R-134a, for example, and low Global Warming Potential (GWP) refrigerants such as HFO-1234yf, for example. The compressor compresses and facilitates a transfer of the refrigerant throughout the system. The compressor includes a suction side and a discharge side. The suction side is referred to as the low-pressure side and the discharge side is referred to as the high-pressure side.

Typically, the evaporator is disposed in a passenger compartment of the vehicle and the condenser is disposed in an engine compartment, or more precisely, in front of a radiator of the vehicle. Within the evaporator, a cold low-pressure two-phase mixture of liquid and vapor refrigerant boils by absorbing heat from the passenger compartment. A cold low-pressure vapor refrigerant then exits from the evaporator. The cold low-pressure vapor refrigerant from the evaporator is received in the compressor and compressed thereby into a hot high-pressure vapor refrigerant. The compressed hot high-pressure vapor refrigerant is then discharged by the compressor to the condenser. As the hot high-pressure vapor refrigerant passes through the condenser, the refrigerant is condensed to a warm high-pressure liquid refrigerant as it transfers the heat absorbed from the passenger compartment and from the compression process to the ambient air outside of the passenger compartment. Exiting the condenser, the warm high-pressure liquid refrigerant passes through an expansion device that regulates the flow of the refrigerant to the evaporator. A temperature of the low-pressure vapor refrigerant returning to the compressor from the evaporator is typically about 40° F. to about 100° F. lower than a temperature of the high-pressure liquid refrigerant exiting the condenser.

An internal heat exchanger such as a double pipe counter flow heat exchanger, for example, is known to be used to take advantage of the temperature differential between the cold low-pressure vapor refrigerant exiting the evaporator and the warm high-pressure liquid refrigerant exiting the condenser to improve the overall cooling capacity of the air conditioning system. The double pipe heat exchanger includes an outer pipe and an inner pipe co-axially located within the outer pipe. The diameter of the inner pipe is smaller than the diameter of the outer pipe, thereby defining an annular gap between the inner pipe and the outer pipe for refrigerant flow. The cold low-pressure vapor refrigerant exiting the evaporator is passed through the inner pipe and the warm high-pressure liquid refrigerant exiting the condenser is passed through the annular gap. Heat is transferred in the internal heat exchanger from the warm high-pressure liquid refrigerant exiting the condenser to the cold low-pressure vapor refrigerant exiting the evaporator. Thus, a cool low-pressure vapor refrigerant returns to the compressor. The decrease in the temperature of the high-pressure liquid refrigerant prior to its flowing through the expansion device causes a decrease in an amount of the liquid refrigerant that flows through the expansion device and an increase in an amount of liquid refrigerant available for absorbing heat in the evaporator. Accordingly, a capacity of the evaporator is also increased, thereby improving the cooling performance of the air conditioning system.

Current internal heat exchangers used in the air conditioning systems include a splitter, which functions as a manifold for the vapor refrigerant and the liquid refrigerant. The splitter, however, is bulky, heavy, and expensive.

It would be desirable to produce an internal heat exchanger that is suitable for use in an air conditioning system of a vehicle, which is easily manufactured, easily conformed to installation requirements, while minimizing a size, a weight, and a complexity of the heat exchanger.

### SUMMARY OF THE INVENTION

In concordance and agreement with the present invention, an internal heat exchanger that is suitable for use in an air conditioning system of a motor vehicle, which is easily manufactured, easily conformed to installation requirements, while minimizing a size, a weight, and a complexity of the heat exchanger, has surprisingly been discovered.

In one embodiment, a heat exchanger, comprises: a first tube configured to receive a first fluid from a condenser of an air conditioning system therein; and a second tube configured to receive a second fluid from an evaporator of the air conditioning system therein, at least a portion of the second tube disposed adjacent at least a portion of the first tube, wherein a longitudinal axis of the portion of the second tube is substantially parallel to a longitudinal axis of the portion of the first tube, and wherein the portion of the second tube is coupled to the portion of the first tube.

In another embodiment, a heat exchanger, comprises: a first tube configured to receive a first fluid therein; and a second tube configured to receive a second fluid therein, at least a portion of the second tube disposed adjacent at least a portion of the first tube, wherein a longitudinal axis of the portion of the second tube is substantially parallel to a longitudinal axis of the portion of the first tube, and wherein the portion of the second tube is coupled to the portion of the first tube by at least one of a weld and an adhesive bead.

The invention also relates to a method of manufacturing a heat exchanger.

The method comprises the step of: forming at least one thermally conductive joint between at least a portion of a first tube and at least a portion of a second tube, wherein the first tube is configured to receive a first fluid from a condenser of an air conditioning system therein and the second tube is configured to receive a second fluid from an evaporator of the air conditioning system therein, and wherein a longitudinal axis of the portion of the second tube is substantially parallel to a longitudinal axis of the portion of the first tube.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic diagram of an internal heat exchanger shown employed in a representative air conditioning system of a motor vehicle;

FIG. 2 is a perspective view a splitterless internal heat exchanger in accordance with the present invention;

FIG. 3 is a cross-sectional view of the heat exchanger illustrated in FIG. 2 taken along line 3-3 according to an embodiment of the present invention;

FIG. 4 is a cross-sectional view of the heat exchanger illustrated in FIG. 2 taken along line 3-3 according to another embodiment of the present invention showing heat transfer elements formed on an inner surface of a vapor line of the heat exchanger; and

FIG. 5 is a cross-sectional view of the heat exchanger illustrated in FIG. 2 taken along line 3-3 according to another embodiment of the present invention showing a vapor line of the heat exchanger coupled to the liquid line of the heat exchanger by a single thermally conductive joint.

### DETAILED DESCRIPTION OF THE INVENTION

The following detailed description and appended drawings describe and illustrate an exemplary embodiment of the invention. The description and drawings serve to enable one skilled in the art to make and use the invention, and are not intended to limit the scope of the invention in any manner.

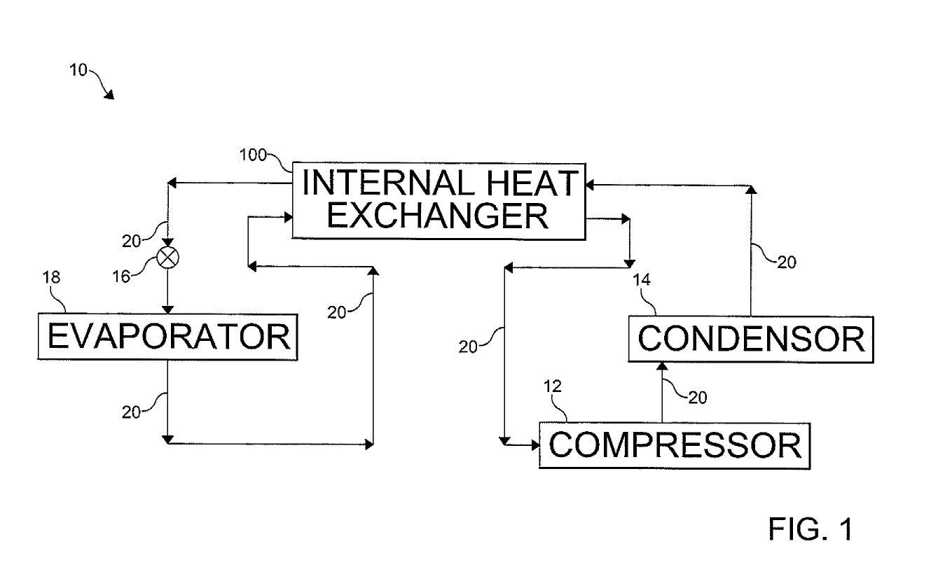

FIG. 1 is a schematic view of an air conditioning system 10 of a motor vehicle (not shown). The air conditioning system 10 includes a compressor 12, a condenser 14, an expansion device 16, and an evaporator 18 fluidly connected by conduits 20. The air conditioning system 10 further includes a counter flow splitterless internal heat exchanger (IHX) 100 to increase a heat transfer capacity of the air conditioning system 10. It is understood that the IHX 100 is not limited to use in vehicle air conditioning systems 10, and can be employed in other non-automotive applications requiring a heat exchanger. It is further understood that the air conditioning system 10 can include other components necessary for operation such as an electronic control unit, an accumulator, sensors, and the like, for example.

A cool low-pressure vapor refrigerant flowing from the IHX 100 is received into the compressor 12 and compressed into a hot high-pressure vapor refrigerant. The hot high-pressure vapor refrigerant is then discharged from the compressor 12 and is received into the condenser 14. Within condenser 14, the hot high-pressure vapor refrigerant is caused to condense into a warm high-pressure liquid refrigerant by transferring heat to the ambient air. The warm high-pressure liquid refrigerant then flows through the IHX 100 into the expansion device 16. The expansion device 16 causes the high-pressure liquid refrigerant from the IHX 100 to expand into a cold low-pressure two-phase mixture of liquid and vapor refrigerant. The expansion device 16 regulates the flow of the refrigerant to the evaporator 18. In the air conditioning system 10, the evaporator 18 may be located either inside or outside a passenger compartment of the motor vehicle. Within the evaporator 18, the cold low-pressure two-phase mixture of liquid and vapor refrigerant absorbs heat from the passenger compartment of the vehicle and is caused to evaporate into the cold low-pressure vapor refrigerant received by the IHX 100.

As shown, the internal heat exchanger 100 is disposed in the air conditioning system 10 between a discharge side of the evaporator 18 and a suction side of the compressor 12 and between a discharge side of the condenser 14 and an inlet side of the expansion device 16. In certain embodiments, the flow of the cold low-pressure vapor refrigerant from the evaporator 18 through the IHX 100 is counter to the flow of the warm high-pressure liquid refrigerant from the condenser 14 through the IHX 100. It is understood that the flow of the cold low-pressure vapor refrigerant from the evaporator 18 can be in any direction in respect of the flow of the warm high-pressure liquid refrigerant from the condenser 14 through the IHX 100 such as in a cross-flow direction or a concurrent flow, for example. The cold low-pressure vapor refrigerant flowing from the evaporator 18 is used to cool the warm high-pressure liquid refrigerant flowing from the condenser 14 to the expansion device 16. Thus, the cool low-pressure vapor refrigerant is returned to the compressor 12

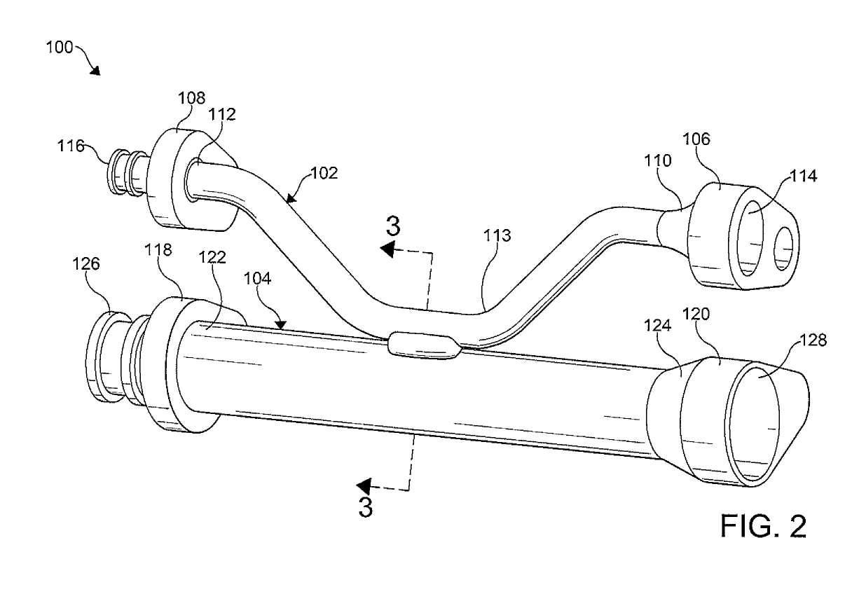

FIG. 2 shows the IHX 100 including a first tube 102 and a second tube 104 according to the present invention. The first tube 102 is configured to receive a first fluid therethrough and the second tube 104 is configured to receive a second fluid therethrough. In certain embodiments, the first fluid and the second fluid have different temperatures. As a non-limiting example, the first fluid is the warm high-pressure liquid refrigerant from the condenser 14 and the second fluid is the cold low-pressure vapor refrigerant from the evaporator 18. It is understood, however, the first fluid and the second fluid can be any fluids as desired. The first tube 102 shown includes a first end 110, a second end 112, and a bent portion 113 extending between the first end 110 and the second end 112. It is understood that the first tube 102 can be substantially linear if desired. In certain embodiments, at least a portion of the bent portion 113 of the first tube 102 is arranged substantially parallel to the second tube 104 in respect of a longitudinal axis of the second tube 104.

Connectors 106, 108 are provided at the first end 110 of the first tube 102 and the second end 112 of the first tube 102, respectively. An inlet 114 of the first tube 102 is in fluid communication with the discharge side of the condenser 14 and an outlet 116 of the first tube 102 is in fluid communication with the inlet side of the expansion device 16 through the conduits 20. A fluid-tight seal is formed between each of the connectors 106, 108 and the conduits 20. It is understood that the fluid-tight seals between the conduits 20 and the respective connectors 106, 108 can be formed by any means as desired such as by solder, braze, or weld connections, adhesive connections, mechanical connectors (e.g. block fittings), or interference fit connections, supported by sealing means such as O-rings, for example.

Similarly, connectors 118, 120 are provided at a first end 122 of the second tube 104 and a second end 124 of the second tube 104, respectively. An inlet 126 of the second tube 104 is in fluid communication with the discharge side of the evaporator 18 and an outlet 128 of the second tube 104 is in fluid communication with the suction side of the compressor 12 through the conduits 20. A fluid-tight seal is formed between each of the connectors 118, 120 and the conduits 20. It is understood that the fluid-tight seals between the conduits 20 and the respective connectors 118, 120 can be formed by any means as desired such as by solder, braze, or weld connections, adhesive connections, mechanical connectors (e.g. block fittings), or interference fit connections, supported by sealing means such as O-rings, for example. In certain embodiments, the second tube 104 is substantially linear. However, it is understood that the second tube 104 have any shape and size as desired.

Each of the tubes 102, 104 shown is a separate component formed from a single piece of material. It is understood that the conduits 102, 104 can be integrally formed and formed by any process as desired such as an extrusion process, for example. It is further understood that the tubes 102, 104 can be formed from any suitable material to facilitate heat transfer such as an aluminum material, a steel material, a stainless steel material, a copper material, or a plastic material, for example. In a non-limiting example, the tubes 102, 104 are formed from an aluminum material to minimize cost and a weight of the IHX 100 and to maximize a heat conductivity and a formability thereof.

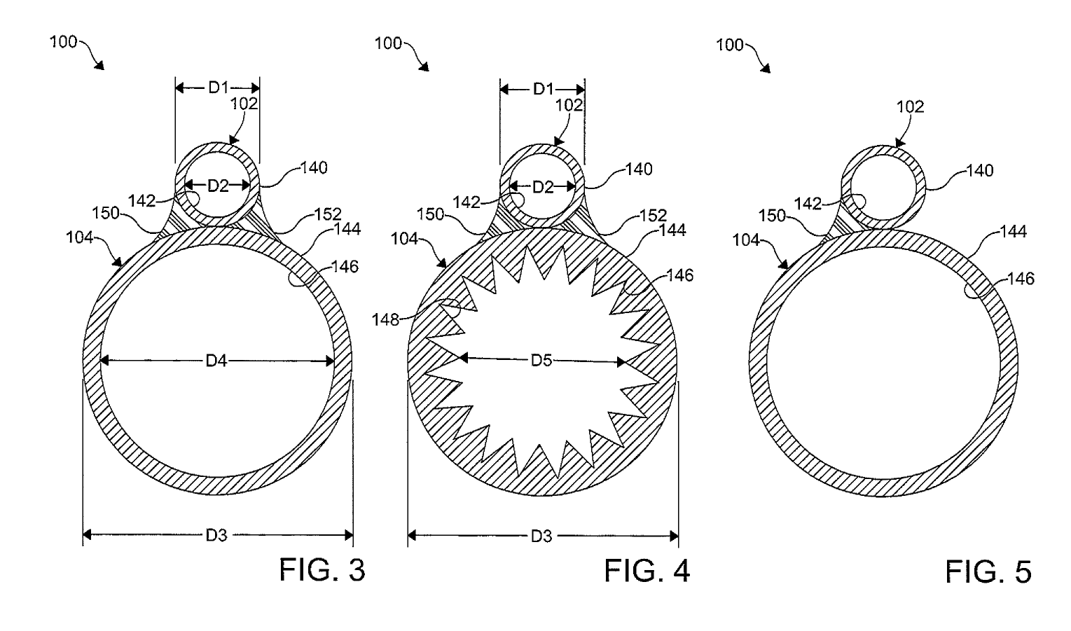

As shown in FIGS. 3-5, the first tube 102 has a relatively smaller diameter than the second tube 104. In certain embodiments, the first tube 102 shown has an outer diameter D1 in a range of about 6.0 mm to about 12.0 mm, specifically about 9.525 mm, an inner diameter D2 in a range of about 4.0 mm to about 10.0 mm, specifically about 7.0 mm, and a cross-sectional flow area in a range of about 12.0 mm² to about 80.0 mm², specifically about 38.8 mm². It is understood, however, that the first tube 102 can have any size and shape as desired. The first tube 102 shown has a generally smooth outer surface 140 and a generally smooth inner surface 142. In certain embodiments, the second tube 104 has an outer diameter D3 in a range of about 15.0 mm to about 20.0 mm, specifically about 19.05 mm, an inner diameter D4 in a range of about 12.0 mm to about 17.0 mm, specifically about 16.0 mm, and a cross-sectional flow area in a range of about 113.0 mm² to about 227.0 mm², specifically about 201.1 mm². It is understood, however, that the second tube 104 can have any size and shape as desired. In certain embodiments, the second tube 104 has a generally smooth outer surface 144 and a generally smooth inner surface 146, as shown in FIGS. 3 and 5. In other embodiments, the inner surface 142 of the first tube 102 and/or the inner surface 146 of the second tube 104 includes at least one heat transfer element 148, as shown in FIG. 4. In a non-limiting example, the inner surface 146 includes twenty (20) heat transfer elements 148 formed thereon. Additional or fewer heat transfer elements 148 than shown can be employed if desired. Various heat transfer elements 148 can be employed in the tubes 102, 104 such as an annular array of elongate ribs formed thereon. Each of the heat transfer elements 148 can have any cross-sectional shape as desired such as a rectangular cross-sectional shape, a triangular cross-sectional shape as shown in FIG. 4, a trapezoidal cross-sectional shape, or an irregular cross-sectional shape, for example. A diameter D5 of the second tube 104 defined by a nose portion of the heat transfer elements 148 is slightly smaller than the inner diameter D4. The nose portion of the heat transfer elements 148 may include a radius if desired. The heat transfer elements 148 shown are circumferentially spaced apart at a substantially uniform predetermined interval forming a plurality of fluid channels therebetween. It is understood, however, that the heat transfer elements 148 can be circumferentially spaced apart at any uniform or non-uniform interval as desired. Additional or fewer fluid channels than shown can be employed if desired. Each of the fluid channels shown has a substantially triangular cross-sectional shape. It is understood that the fluid channels can have any cross-sectional shape as desired. Corners of the fluid channels formed where the heat transfer elements 148 transition to the inner surface 146 of the second tube 104 may include a radius if desired. In certain embodiments, the heat transfer elements 148 extend substantially parallel to a central axis of the respective tubes 102, 104 to form a plurality of linear fluid channels. In other certain embodiments, the heat transfer elements 148 extend substantially around and along the central axis of the respective tube 102, 104 to form a plurality of helical fluid channels. It is understood, however, that the heat transfer elements 148 can be formed on the inner surface 142 of the first tube 102 and/or the inner surface 146 of the second tube 104 in any suitable configuration or pattern as desired.

To assemble the IHX 100, at least a portion of the first tube 102 is disposed adjacent at least a portion of the second tube 104 so that a longitudinal axis of the portion of the first tube 102 is substantially parallel to a longitudinal axis of the portion of the second tube 104. In certain embodiments, the bent portion 113 of the first tube 102 is disposed adjacent the portion of the second tube 104 having the outer surface 140 of the first tube 102 abut the outer surface 144 of the second tube 104. It is understood, however, that the portion of the first tube 102 may be positioned adjacent the portion of the second tube 104 forming a space between the tubes 102, 104. In certain embodiments illustrated in FIGS. 3-4, the portion of the first tube 102 is coupled to the portion of the second tube 104 along both sides of the tubes 102, 104 by a first thermally conductive joint 150 and a second thermally conductive joint 152 extending substantially parallel to the respective longitudinal axes of the portions of the tubes 102, 104. As a non-limiting example, at least one of the first thermally conductive joint 150 and the second thermally conductive joint 152 is a weld or an adhesive bead. To this end, the portion of the first tube 102 can be welded and/or adhesively bonded to the portion of the second tube 104. The thermally conductive joints 150, 152 permit a desired heat conductivity between the fluids without an additional heat transfer element disposed between the first tube 102 and the second tube 104. As a non-limiting example, each of the thermally conductive joints 150, 152 has a length of about 425 mm and a cross-sectional area of about 12 mm², and contacts an area of the first tube 102 of about 2,040 mm² and an area of the second tube 104 of about 2,295 mm² to reach the desired heat conductivity between the fluids. It is understood, however, that each of the thermally conductive joints 150, 152 can have any suitable length, cross-sectional area, and area of contact with the tubes 102, 104 based upon the desired heat conductivity between the fluids.

As shown in FIG. 5, the portion of the first tube 102 may be coupled to the portion of the second tube 104 along a single side of the tubes 102, 104 by only one of the first thermally conductive joint 150 and the second thermally conductive joint 152 extending substantially parallel to the respective longitudinal axes of the portions of the tubes 102, 104. In certain embodiments, the IHX 100 having the first tube 102 coupled to the second tube 104 along only one of the sides of the tubes 102, 104 yields about 65% of the heat conductivity between the fluids than the IHX 100 having the first tube 102 coupled to the second tube 104 along both sides of the tubes 102, 104. It is understood that other connector types can be used between the tubes 102, 104 such as clamps or bands, for example.

During the operation of the air conditioning system 10, a cool low-pressure vapor refrigerant flowing from the IHX 100 is received into the compressor 12 and compressed into a hot high-pressure vapor refrigerant. The hot high-pressure vapor refrigerant is then discharged from the compressor 12 and is received into the condenser 14. Within the condenser 14, the hot high-pressure vapor refrigerant is caused to condense into a warm high-pressure liquid refrigerant by transferring heat to the ambient air. The warm high-pressure liquid refrigerant then flows through the first tube 102 of the IHX 100 and is cooled. Thereafter, the high-pressure liquid refrigerant flows through the expansion device 16 and is caused to expand into a low-pressure two-phase mixture of liquid and vapor refrigerant. The expansion device 16 regulates the flow of the refrigerant to the evaporator 18. Within the evaporator 18, the low-pressure two-phase mixture of liquid and vapor refrigerant absorbs heat from the passenger compartment of the vehicle and is caused to evaporate into a cold low-pressure vapor refrigerant. The cold low-pressure vapor refrigerant then flows from the evaporator 18 into the second tube 104 of the IHX 100. A direction of flow of the cold low-pressure vapor refrigerant through the second tube 104 is counter to the direction of flow of the warm high-pressure liquid refrigerant flowing through the first tube 102.

Within the IHX 100, the cold low-pressure vapor refrigerant absorbs heat from the warm high-pressure liquid refrigerant. Thereafter, the cool low-pressure vapor refrigerant flows to the compressor 12 to be compressed, and the high-pressure liquid refrigerant flows to the expansion device 16 as described hereinabove. The heat transfer elements 148 of the IHX 100 increase a surface area of the second tube 104 exposed to the cool low-pressure vapor refrigerant flowing through the IHX 100. As a result, a performance of the IHX 100 (e.g. an amount of heat exchanged between the fluids) and an efficiency of the IHX 100 (e.g. a rate at which the heat exchange occurs) are increased. Because of the elimination of the splitter for the IHX 100, a size, a weight, and particularly a complexity of the IHX 100 can be minimized.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A heat exchanger, comprising:
a first tube configured to receive a first fluid from a condenser of an air conditioning system therein; and
a second tube configured to receive a second fluid from an evaporator of the air conditioning system therein, at least a portion of the second tube disposed adjacent at least a portion of the first tube, wherein a longitudinal axis of the portion of the second tube is substantially parallel to a longitudinal axis of the portion of the first tube, and wherein the portion of the second tube is coupled to the portion of the first tube.

2. The heat exchanger according to claim 1, further comprising at least one heat transfer element formed on an inner surface of at least one of the first tube and the second tube.

3. The heat exchanger according to claim 1, wherein a cross-sectional flow area of the first tube is less than a cross-sectional flow area of the second tube.

4. The heat exchanger according to claim 1, wherein the portion of the second tube is coupled to the portion of the first tube by at least one thermally conductive joint.

5. The heat exchanger according to claim 4, wherein at least one of a length and a cross-sectional area of the at least one thermally conductive joint is determined based upon a desired heat conductivity between the first fluid and the second fluid.

6. The heat exchanger according to claim 4, an area of contact of the at least one thermally conductive joint with at least one of the first tube and the second tube is determined based upon a desired heat conductivity between the first fluid and the second fluid.

7. The heat exchanger according to claim 4, wherein the at least one thermally conductive joint is a weld.

8. The heat exchanger according to claim 4, wherein the at least one thermally conductive joint is an adhesive bead.

9. A heat exchanger, comprising:
a first tube configured to receive a first fluid therein; and
a second tube configured to receive a second fluid therein, at least a portion of the second tube disposed adjacent at least a portion of the first tube, wherein a longitudinal axis of the portion of the second tube is substantially parallel to a longitudinal axis of the portion of the first tube, and wherein the portion of the second tube is coupled to the portion of the first tube by at least one of a weld and an adhesive bead.

10. The heat exchanger according to claim 9, wherein the first fluid is a liquid refrigerant and the second fluid is a vapor refrigerant.

11. The heat exchanger according to claim 9, further comprising at least one heat transfer element formed on an inner surface of at least one of the first tube and the second tube.

12. The heat exchanger according to claim 9, wherein a cross-sectional flow area of the first tube is less than a cross-sectional flow area of the second tube.

13. The heat exchanger according to claim 9, wherein at least one of a length and a cross-sectional area of at least one of the weld and the adhesive bead is determined based upon a desired heat conductivity between the first fluid and the second fluid.

14. The heat exchanger according to claim 9, an area of contact of at least one of the weld and the adhesive bead with at least one of the first tube and the second tube is determined based upon a desired heat conductivity between the first fluid and the second fluid.

15. A method of manufacturing a heat exchanger, comprising the step of:
forming at least one thermally conductive joint between at least a portion of a first tube and at least a portion of a second tube, wherein the first tube is configured to receive a first fluid from a condenser of an air conditioning system therein and the second tube is configured to receive a second fluid from an evaporator of the air conditioning system therein, and wherein a longitudinal axis of the portion of the second tube is substantially parallel to a longitudinal axis of the portion of the first tube.

16. The method according to claim 15, wherein a cross-sectional flow area of the first tube is less than a cross-sectional flow area of the second tube.

17. The method according to claim 15, wherein at least one of a length and a cross-sectional area of the at least one thermally conductive joint is determined based upon a desired heat conductivity between the first fluid and the second fluid.

18. The method according to claim 15, wherein an area of contact of the at least one thermally conductive joint with at least one of the first tube and the second tube is determined based upon a desired heat conductivity between the first fluid and the second fluid.

19. The method according to claim 15, wherein the at least one thermally conductive joint is a weld.

20. The method according to claim 15, wherein the at least one thermally conductive joint is an adhesive bead.
